(19) United States
(12) Patent Application Publication
(10) Pub. No.: US 2017/0285774 A1
(43) Pub. Date: Oct. 5, 2017

(54) CHARACTERIZATION AND SIMULATION OF WRITING INSTRUMENTS

(71) Applicants: Kunjal Parikh, San Jose, CA (US); Thomas Agung Nugraha, Tokyo (JP); Arvind Kumar, Beaverton, OR (US); Akihiro Takagi, San Mateo, CA (US); John F. Jacobs, San Jose, CA (US)

(72) Inventors: Kunjal Parikh, San Jose, CA (US); Thomas Agung Nugraha, Tokyo (JP); Arvind Kumar, Beaverton, OR (US); Akihiro Takagi, San Mateo, CA (US); John F. Jacobs, San Jose, CA (US)

(21) Appl. No.: 15/089,290

(22) Filed: Apr. 1, 2016

(51) Int. Cl. G06F 3/0354; G06F 3/01; G06F 3/16; G06F 3/038

(52) U.S. Cl. CPC G06F 3/03545; G06F 3/0383; G06F 3/016; G06F 3/16

(57) ABSTRACT

An active stylus enables an electronic device to provide a user-friendly user input. The active stylus uses various sensors and feedback mechanisms to characterize or simulate the audible and haptic feedback associated with various writing instruments. The sensors capture pressure, speed, vibration, sound, and other characteristics of using a specific writing instrument on a given surface. This enables the active stylus to simulate the writing instrument accurately while avoiding increased haze and optical distortions due to etching or engineered film.

### TECHNICAL FIELD

Embodiments described herein generally relate to simulation of writing instruments using an electronic device stylus.

### BACKGROUND

There is an increasing demand for touch-screen electronic devices, including smartphones, tablets, and consumer point-of-sale terminals. To facilitate input, some touch screen devices are compatible with a stylus. The stylus often takes the form of a pen-shaped device. While the stylus offers increased control over the input, there is little or no friction between the stylus and the touchscreen, resulting in a significantly different experience than conventional pen or pencil usage.

Existing solutions for approximating a writing instrument input experience include altering the writing surface to simulate the sensation of pen or pencil. However, these solutions sacrifice the optics of the touchscreen device. For example, some solutions use microscopic etching on the device screen glass to increase the coefficient of friction, thereby attempting to approximate the impression of pen and paper experience. However, this etching introduces haze and other optical distortions negatively affect the user experience.

Another solution for simulating writing friction of device screen glass is to apply an engineered film. These films are often scratch resistant and increase the coefficient of friction of device screen glass. One such film is comprised of polyethylene terephthalate (PET), however PET films have not proven reliable in consumer devices. PET films also introduce haze and other optical distortions.

The increased haze and optical distortions due to etching or engineered film reduce the apparent screen resolution and reduce the apparent device brightness. The haze and optical distortions may be mitigated by increasing the device resolution, which increases the cost of the device. The haze and optical distortions may also be mitigated by increasing the device brightness, which increases power consumption and decreases battery life.

It is desirable to provide an improved solution for approximating a writing instrument input experience for electronic devices.

### BRIEF DESCRIPTION OF THE DRAWINGS

FIG. 1 is a sectional view of an active stylus, in accordance with at least one embodiment of the invention.

FIG. 2 is a graph of a sinusoidal vibration characterization, in accordance with at least one embodiment of the invention.

FIG. 3 is a flow chart of audio feedback generation, in accordance with at least one embodiment of the invention.

FIG. 4 is a block diagram of a wired active stylus system, in accordance with at least one embodiment of the invention.

FIG. 5 is a block diagram of a wireless active stylus system, in accordance with at least one embodiment of the invention.

FIG. 6 is an image of a paper cross-section, in accordance with at least one embodiment of the invention.

FIG. 7 is a graph of a soundwave texture modeling characterization, in accordance with at least one embodiment of the invention.

FIG. 8 is a graph of a surface roughness map characterization, in accordance with at least one embodiment of the invention.

FIG. 9 is a block diagram of an adaptive feedback modeling method, in accordance with at least one embodiment of the invention.

FIG. 10 is a block diagram illustrating an active stylus in the example form of a computer system, within which a set or sequence of instructions may be executed to cause the machine to perform any one of the methodologies discussed herein, according to an example embodiment.

### DESCRIPTION OF EMBODIMENTS

A technical problem faced by an electronic device is providing a user-friendly user input. Technical solutions described herein provide processes and equipment for an active stylus that characterizes and simulates conventional writing instruments. Simulated instruments may include various types of pens, pencils, paintbrushes, highlighters, markers, charcoal, chalk, erasers, paints combs, chisels and other types of writing or marking instruments. Each type of writing instrument has an associated set of audible and haptic feedback. The active stylus uses various sensors to characterize (e.g. capture) the audible and haptic feedback, and then uses various feedback mechanisms to simulate the audible and haptic feedback.

In an example, the active stylus includes a high frequency actuator, a microphone assembly, a pressure sensor, a gyroscope, an accelerometer, and other sensors and feedback mechanisms. The sensors capture pressure, speed, vibration, sound, and other characteristics of using a specific writing instrument on a given surface. This enables the active stylus to simulate the writing instrument accurately while avoiding increased haze and optical distortions due to etching or engineered film.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

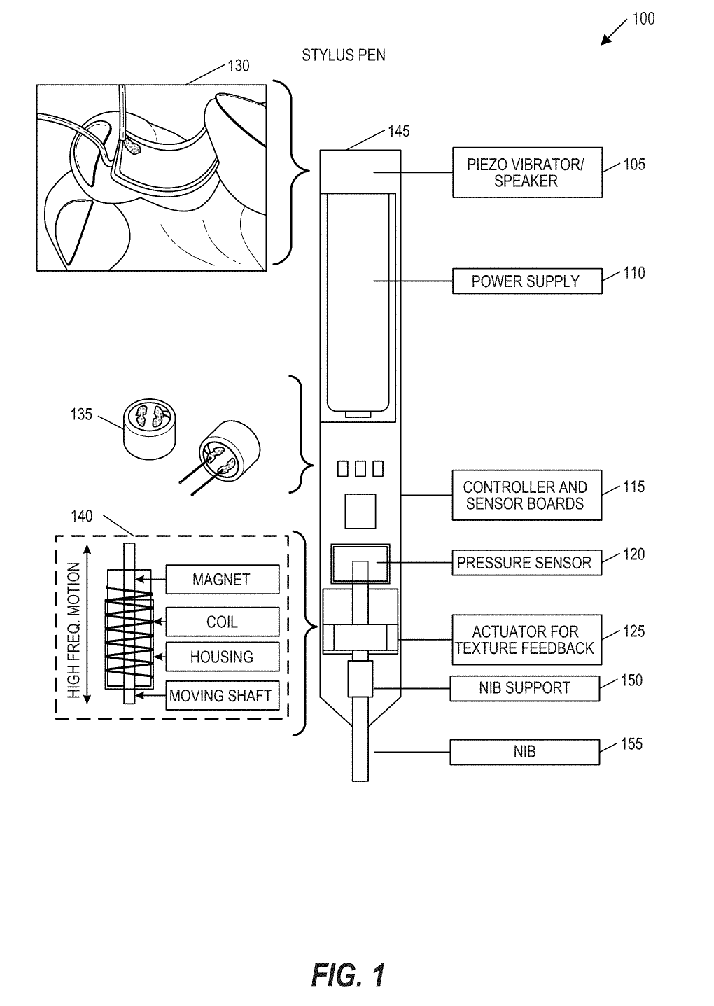

FIG. 1 is a sectional view of an active stylus 100, in accordance with at least one embodiment of the invention. Active stylus 100 includes various sensors and feedback mechanisms within the stylus housing 145. Stylus 100 includes a speaker 105, where speaker 105 may include a piezoelectric element. Speaker 105 may be used as a microphone, or a separate microphone may be used to capture audio data. In an example, an electret condenser microphone 135 is used, where microphone 135 may be positioned toward the bottom of the stylus to capture audio created by writing on a surface. Speaker 105 may be implemented in a rolled form factor 130. Speaker 105 may use the stylus housing 145 as a speaker vibration plate.

Stylus 100 includes a power supply 110 to power various sensors and feedback mechanisms, such as using a rechargeable or replaceable battery. Stylus 100 includes various controller and sensor boards 115. The controller provides processing of input and output signals, and may be implemented as a microcontroller (MCU) or microprocessor (MPU). Sensors may include an accelerometer, gyroscope, or other types of input sensors. The accelerometer data is used to detect acceleration and speed of writing. In an example, a relatively high acceleration is used to generate a light writing instrument input, or is used to generate a smooth writing instrument input. The accelerometer data is also used to detect writing instrument orientation, such as by detecting the direction of gravity relative to the current orientation of the stylus 100. Input data from multiple sensors are combined to increase accuracy and precision in characterizing and simulating writing instrument input. For example, measurements from the accelerometer and gyroscope may be combined to characterize stylus position, velocity, acceleration, and higher order positional derivatives. Sensors may include various surface mount technology (SMT) components. For example, the sensors and feedback mechanisms within the stylus may use microelectromechanical systems (MEMS) technology, nanoelectromechanical systems (NEMS), or other small form factor sensors and feedback mechanisms.

Stylus 100 includes a pressure sensor 120. Pressure sensor 120 may detect a pressure applied when the stylus 100 is pressed against a surface. The pressure may be detected in a single dimension, thereby characterizing the perpendicular component of the pressure applied when the stylus 100 is pressed against a surface. The pressure may be detected in multiple directions. In an example, stylus housing 145 includes a nib support 150, where nib support 150 creates a nib displacement at the pressure sensor 120 in multiple directions. For example, when a lower nib portion is deflected to the right, the nib support 150 causes a nib upper portion to deflect to the left.

Stylus 100 includes an actuator 125. Actuator 125 may be used to detect or provide translational movement of the nib 155. Actuator 125 may include a coil configuration 140, which includes a magnet and a moving shaft within a coil. The shaft may be formed from a magnetic material or may include a magnetic material affixed to a portion of the shaft. In this inductive coil sensor configuration 140 (e.g., search coil configuration), movement of the magnetic portion of the shaft within the coil may cause a current to flow in the coil, where the current is proportional to the position or movement of the shaft. The shaft may be separate from the magnetic material, and the coil configuration 140 may include a variable reluctance sensor that detects proximity of the moveable shaft and the magnetic material.

Actuator 125, coil configuration 140, or other mechanisms within the stylus 100 may be used to provide haptic feedback. For example, actuator 125 may provide simulated tactile feedback, such as vibration, pressure, touch, or texture. Actuator 125, eccentric rotating mass (ERM) vibration motor (not shown), or other mechanisms may provide simulated kinesthetic feedback, such as a sensation of a shift in the weight or center of mass. The coil configuration 140 structure may also be used to provide haptic feedback. In an example, coil configuration 140 forms a solenoid, and a current passed through the coil causes the shaft to move. Actuator 125 may include the coil configuration 140 or may be separate from the coil configuration 140. For example, the coil configuration 140 may be used to detect translational movement of the nib 155, and actuator 125 may be used to provide haptic feedback.

Stylus 100 includes a nib 155 that comes into contact with the writing surface. Nib 155 may include a material that provides touchscreen input, such as a capacitive nib. Nib 155 may be manufactured to include a surface that provides friction when used with a device screen. Nib 155 may be replaceable to provide other nib shapes, sizes, fiction coefficients, or other features. Nib 155 may be replaceable with a writing instrument to allow for writing instrument characterization. For example, nib 155 or a larger portion of the stylus housing 145 may be disconnected and replaced with a pencil, pen, paintbrush, or other writing instrument to characterize the audible and haptic feedback associated with that writing instrument. In an example, nib 155 may be replaced with an accompanying instrument to writing, such as an eraser, paint chisel, or the like. In an example, one or more of the pressure sensor 120, the actuator 125, the nib support 150 and the nib 155 may be duplicated in the active stylus 100 at a different place on the housing 145, such as at the proximal end of the housing 145. For example, an erase type nib, not shown, may be attached to the proximal end of the housing 145 (e.g., near the speaker 105) and include accompanying sensors and actuators to simulate (e.g., via haptic or auditory output) the dragging of a rubbery, vinyl eraser over the surface.

The active stylus 100 may simulate various types of writing instruments. In addition to the audible and haptic feedback, the stylus may simulate the line width, shape, or intensity of the simulated writing instrument. For example, simulating a ball-point pen may include generating a relatively uniform line of ink, whereas simulating a felt tip pen may include simulating a line of ink whose width increases with decreased stylus speed. In another example, simulating a pencil or paintbrush may include simulating a line of graphite whose size depends on the angle of the stylus, the speed of the stylus, and the pressure applied to the stylus. Various algorithms may be applied to characterize or simulate writing instruments. For example, an inking algorithm may be used to define the size, shape, or intensity of a simulated line.

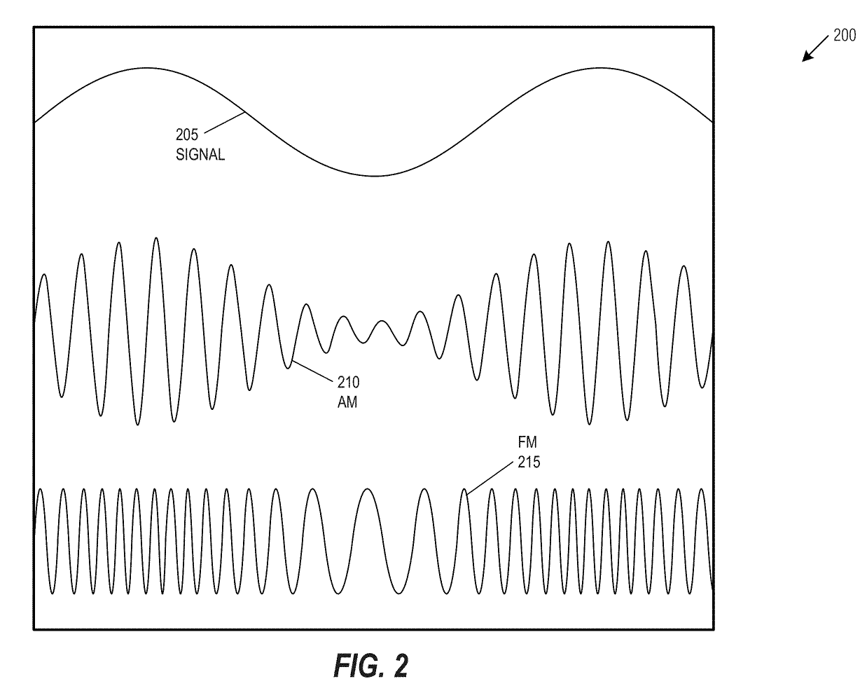

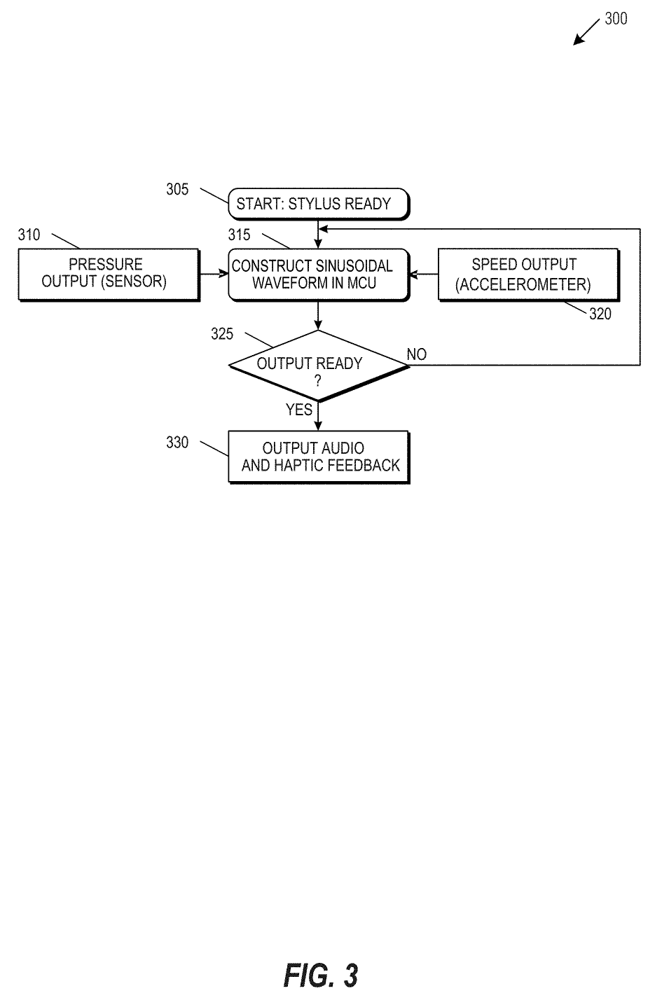

FIG. 2 is a graph of a sinusoidal vibration characterization 200, in accordance with at least one embodiment of the invention. Characterization 200 includes an output sinusoidal signal 205, an amplitude modulated signal 210, and a frequency modulated signal 215. The amplitude modulated signal 210 may be captured by a pressure sensor, and may be used to represent information about the magnitude of the stylus pressure being applied, i.e., how hard or soft the stylus is being pressed against a surface. The frequency modulated signal 215 may be captured by an accelerometer, and may be used to represent the speed of writing. Either the amplitude modulated signal 210 or the frequency modulated signal 215 may be used to form the output sinusoidal signal 205. In addition, because these signals may be treated as linearly additive, the output sinusoidal signal 205 may be formed from a combination (i.e., superposition) of the amplitude modulated signal 210 and the frequency modulated signal 215. The use of superposition allows multiple writing input characteristics to be determined or modeled independently, and allows an output signal to be generated dynamically based on a combination of multiple writing input characteristics. A flowchart of this combination in shown in FIG. 3.

FIG. 3 is a flow chart of audio feedback generation 300, in accordance with at least one embodiment of the invention. Feedback generation 300 may begin in a standby mode until the stylus is determined to be ready 305 to combine characterized signals and provide an output. Stylus may be determined to be ready 305 as soon as it is powered on, or it may delay until receiving an input that is determined to require an output. For example, the stylus may wait until receiving a pressure input to indicate the stylus is being applied to a surface before entering the ready state 305. Once ready 305, the stylus may characterize the current pressure being applied from an input pressure sensor 310 and construct an appropriate pressure simulation sinusoidal waveform output 315. Similarly, stylus may characterize the speed being applied from an input acceleration sensor 320 and construct an appropriate speed simulation sinusoidal waveform output 315. The device processor (e.g., microcontroller (MCU)) may construct a combination sinusoidal waveform (e.g., via superposition), such as by combining the pressure simulation sensor output 310 and speed simulation sensor output 320. The MCU may perform Fourier transfer analysis on the pressure simulation waveform output 310 and speed simulation waveform output 320 to identify one or more band of frequency responses being received from the sensors. For example, a particular frequency may be associated with a pencil line being drawn across paper at a constant velocity, and the Fourier analysis may identify a frequency band that correspond with the constant velocity pencil gesture.

The stylus may analyze the output sinusoidal waveform to determine 325 if it is ready to be output. For example, the waveform may be determined to be too short in duration or too small in amplitude, such as may be associated with an unintentional use of the stylus. This determination is then used to reanalyze and reconstruct the sinusoidal waveform 315. In an example, sinusoidal reconstruction includes increasing the amplitude by a scale factor, or increasing the duration, such as by identifying and duplicating periodic portions of the sinusoidal waveform.

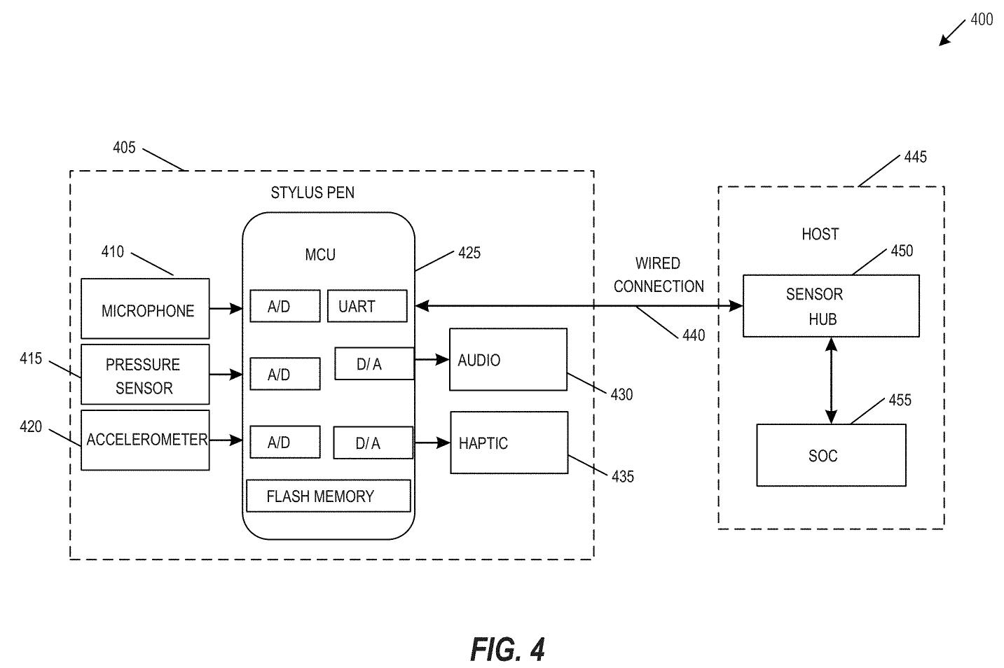

Once the sinusoidal waveform is determined 325 to be ready to be output, the stylus outputs 330 the audio and haptic feedback. The output 330 of the audio and haptic feedback may include a simulated amplitude modulation to simulate an amount of writing instrument pressure, a simulated frequency modulation to simulate the speed of the stylus device, or a combination of simulated amplitude and frequency modulation. The type of audio and haptic feedback may be selected using a selector input on the stylus or using a connected electronic device. For example, the touchscreen device receiving the stylus input may also be used to select the writing instrument to be simulated by the stylus. In another example, a selection switch on the stylus provides the ability to select between only audio output, only haptic feedback output, or a combination of audio and haptic feedback. The feedback model may be stored in the stylus or in the connected electronic device. An example system including a stylus and connected external device is shown in FIG. 4.

FIG. 4 is a block diagram of a wired active stylus system 400, in accordance with at least one embodiment of the invention. System 400 includes a stylus 405 and a host 445 connected by wired connection 440. The stylus 405 includes various input sensors, such as a microphone 410, a pressure sensor 415, and an accelerometer 420. Each of the input sensors provide input sensor data to an analog to digital converter (A/D) within the stylus MCU 425. The MCU 425 provides simulated output via digital to analog converters (D/A) to an audio output device 430 or a haptic output device 435.

The MCU 425 also provides raw or processed input data via a universal asynchronous receiver/transmitter (UART) to the wired connection 440, which provides the input data to the host 445. Host 445 includes a sensor hub 450 to receive the input sensor data. Sensor hub 450 provide input sensor data to a host processor, where the host processor may be implemented as a system-on-chip (SoC) 455.

The stylus 405 and host 445 within active stylus system 400 function together to characterize and simulate a writing instrument based on an adaptive feedback model. The adaptive feedback model is initialized using a baseline set of simulated writing instrument characteristics, and the adaptive feedback model combines newly received inputs with the baseline set of simulated writing instrument characteristics. For example, the adaptive feedback model may update model characteristics based on a user's writing style or based on a detection of using the stylus on a previously unknown surface. The baseline set of characteristics may be initialized using a previously characterized combination of writing instrument and writing surface, such as a paintbrush on canvas. The baseline set of characteristics may be initialized based on a set of training inputs provided by the user, such as the user providing a writing sample using pen and paper.

The adaptive feedback model may be generated dynamically. The feedback model may be generated and updated in the stylus 405 or in the host 445. For example, the adaptive feedback model may be used to simulate a writing instrument, and the stylus 405 may receive sensor input and continually provide the sensor input to the host processor SoC 455 to update the feedback model. The adaptive feedback model may be generated using a lookup table. For example, an updated feedback model lookup table has been generated, the host 445 provides the updated lookup table to the stylus 405 to be stored in a local flash memory. The use of a lookup table further reduces latency during simulation. For example, instead of processing data from all sensors to generate simulated audible and haptic feedback, a Fourier analysis output of sensor data may be normalized (e.g., binned) to a particular frequency band and matched with a similar gesture frequency band within a gesture lookup table, where the lookup table provides corresponding data used to simulate the audible and haptic feedback. In another example, the lookup table may include multiple gesture wavelets (e.g., short duration signal waveform), and the gesture wavelet is convolved or cross-correlated with the sensor input data to determine whether the gesture is detected in the sensor input data. The adaptive feedback model may be generated or implemented using a software library. For example, the adaptive feedback model library may include simulated audible and haptic feedback, and may provide a well-defined library interface that the stylus 405 uses to simulate audible and haptic feedback.

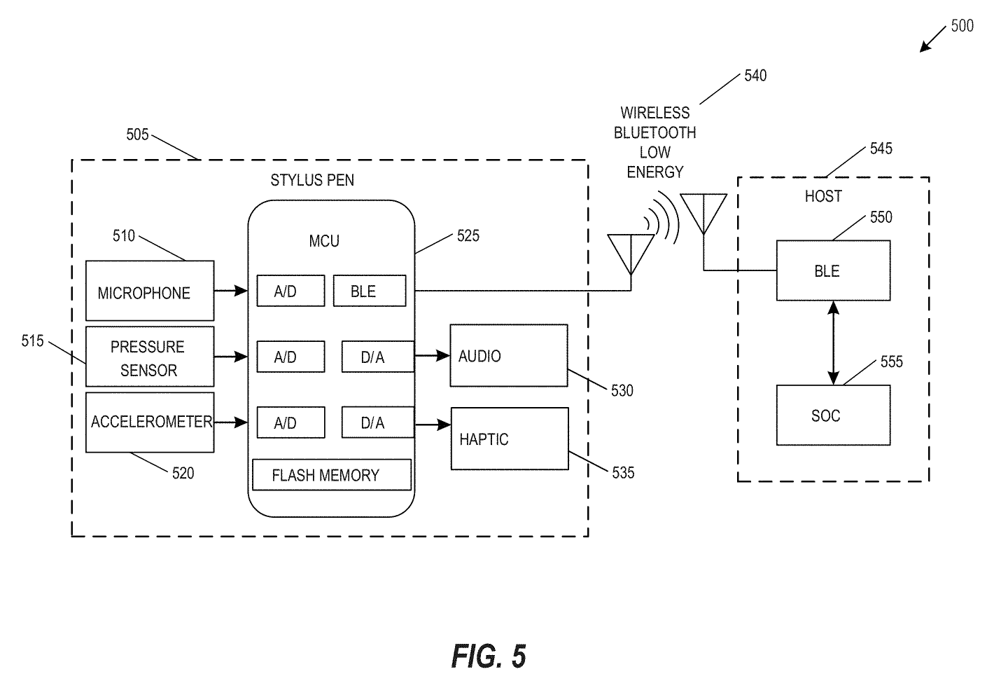

FIG. 5 is a block diagram of a wireless active stylus system 500, in accordance with at least one embodiment of the invention. System 500 includes a stylus 505 and a host 545 connected by wireless connection 540. The stylus 505 includes various input sensors, such as a microphone 510, a pressure sensor 515, and an accelerometer 520. The input sensors provide input sensor data the MCU 525, and the MCU 525 provides simulated output via digital to analog converters (D/A) to an audio output device 530 or a haptic output device 535. MCU 525 also provides raw or processed input data to the wireless connection 540, which provides the input data to the host 545. Host 545 includes a wireless sensor hub 550, such as a Bluetooth low energy (BLE) hub 550. Sensor hub 550 provide input sensor data to a host processor, such as SoC 455. Though wireless connection 540 is shown as a BLE connection other forms of wireless communication may be used, such as Wi-Fi, infrared (IR), near-field communications (NFC), radio frequency identification (RFC), or other forms of wireless communication. The stylus 505 may also transmit or receive data for the motion inputs or feedback model updates (e.g., library updates) through a wireless or wired network connection to host 545. For example, host 545 may be implemented as an internet-based service (e.g., “the cloud”), as a Software as a Service (SaaS), or other remote processing entity.

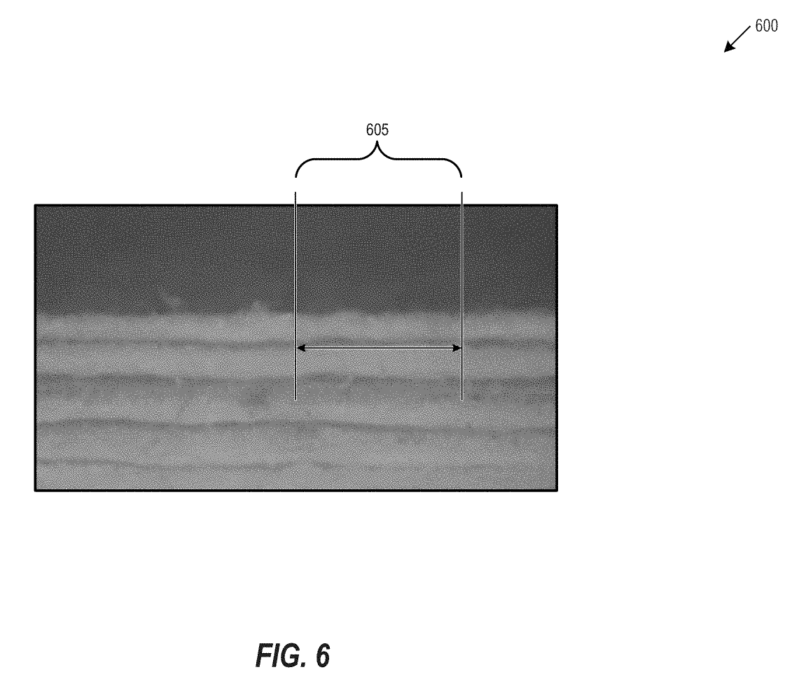

FIG. 6 is an image of a paper cross-section 600, in accordance with at least one embodiment of the invention. Cross-section 600 shows a portion of paper formed using multiple layers. A writing instrument simulation may be characterized using a statistically representative portion of the paper, such as paper width 605. The paper width 605 may be determined dynamically. For example, the paper width 605 may begin as an initial minimum width, and if the sensor input variation using the minimum width exceeds a sensor input variation threshold, then the required paper width is extended until the input data falls below the sensor input variation threshold. The use of a sensor input variation threshold and a statistically representative analysis reduces the amount of data necessary for initial characterization, while providing a sufficiently accurate set of audio and haptic feedback.

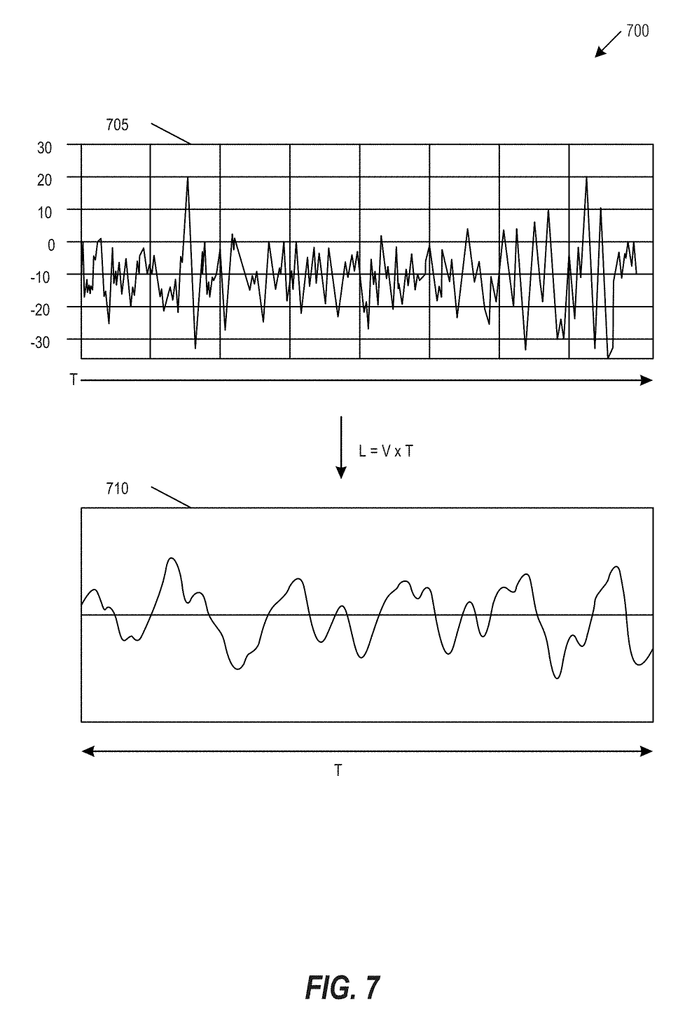

FIG. 7 is a graph of a soundwave texture modeling characterization 700, in accordance with at least one embodiment of the invention. Characterization 700 begins by receiving an audio input soundwave 705, such as a soundwave generated by a microphone capturing the sound of the friction of a pencil drawing on paper. The input soundwave 705 is used to generate a surface texture model 710, where the surface texture model 710 represents physical features of the writing surface. In an example, the amplitude of the displacement within input soundwave 705 is interpreted to be proportional to the magnitude of the velocity of the pencil tip relative to the paper surface, and using the approximation of length equaling the product of velocity and time, the changing magnitude of the input soundwave 705 is used to generate the surface texture model 710. Various additional digital signal processing (DSP) techniques or algorithms may be applied in using the input soundwave 705 to generate the surface texture model 710, such as averaging (e.g., moving window averages), normalization, outlier detection and removal, or other DSP techniques or algorithms.

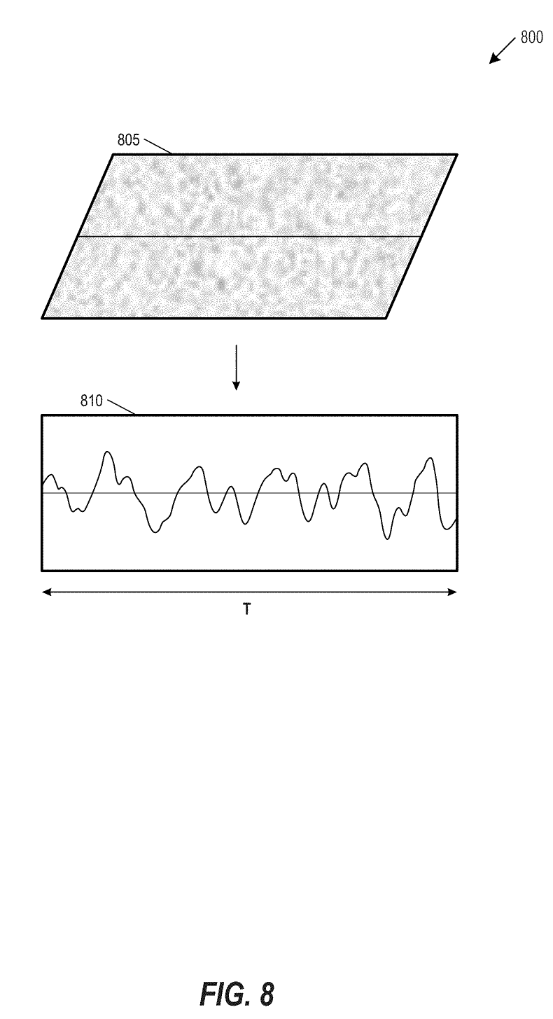

FIG. 8 is a graph of a surface roughness map characterization 800, in accordance with at least one embodiment of the invention. Characterization 800 begins by receiving a surface roughness map 805, where map 805 represents the texture of a surface to be generated. For example, darker regions with surface roughness map 805 represent higher areas of a surface, and conversely lighter regions represent lower areas of a surface. Surface roughness map 805 may be determined using one or more surface characterization sensors, such as a pressure sensor, inductive coil sensor, accelerometer, or gyroscope. Surface roughness map 805 may be a set of previously determined roughness values, such as might be provided by a magnified image of a surface to be simulated. Surface roughness map 805 may be used to generate a surface texture model 810, where the surface texture model 810 represents physical features of the writing surface. Surface roughness map 805 may also be stored as a 2-D set of values (e.g., stored as an matrix of M rows and N columns), and the surface texture model 810 may be generated dynamically as a horizontal path through the surface roughness map 805, as a vertical path, as a stochastically determined path, or as another path.

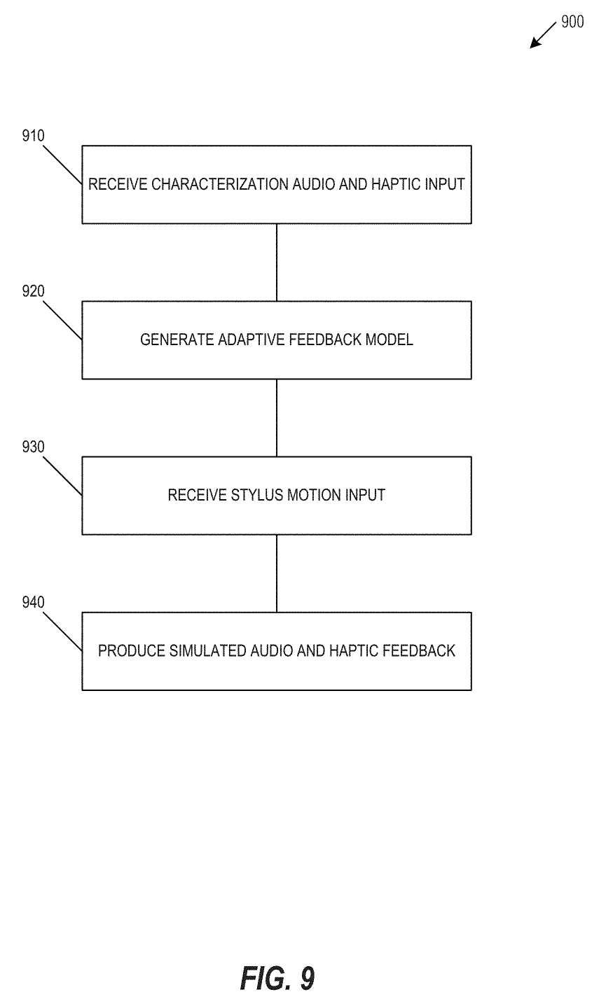

FIG. 9 is a block diagram of an adaptive feedback modeling method 900, in accordance with at least one embodiment of the invention. Adaptive feedback modeling method 900 includes receiving 910 a characterization audio input and a haptic input. The characterization input may be associated with a particular combination of writing instrument and writing surface, such as a pencil writing on paper. Receiving 910 the characterization audio input may include receiving audio input from a stylus microphone. Receiving 910 the characterization haptic input includes receiving the haptic input from a stylus haptic sensor, such as an accelerometer, a pressure sensor, a variable reluctance sensor, an inductive coil sensor, or other haptic input sensor. In an example, the audio input and haptic input are obtained from ongoing stylus use.

Method 900 includes generating 920 an adaptive feedback model based on the audio input and haptic input. Generating 920 the adaptive feedback model may include generated a baseline set of simulated writing instrument characteristics and update the model characteristics based on a user's writing style or based on receiving additional stylus input.

Method 900 includes receiving 930 stylus motion input. Receiving 930 the stylus motion input may include receiving motion input from a motion or pressure sensor, such as an accelerometer, a gyroscope, a pressure sensor, a variable reluctance sensor, an inductive coil sensor, or other motion or pressure sensor. The stylus motion input may be used to update the adaptive feedback model or to produce 940 a simulated output.

Method 900 includes producing 940 simulated audio and haptic feedback. Producing 940 simulated audio feedback includes outputting a sound waveform via a speaker that simulates the sound of using a writing instrument on a surface. In an example, the simulation sound output waveform includes only the sounds associated with the simulated writing instrument. In an example, the simulation sound output waveform modifies the sound output to simulate the sound and texture of the simulated writing instrument, such as by amplifying portions of the audio waveform to simulate a high-amplitude portion of a writing surface roughness map. Producing 940 simulated haptic feedback may include providing at least one of a tactile feedback and a kinesthetic feedback. Providing the haptic feedback may include providing the haptic feedback from a stylus haptic feedback mechanism, such as an actuator, an eccentric rotating mass, an electromagnetic vibrator, or other haptic feedback mechanism.

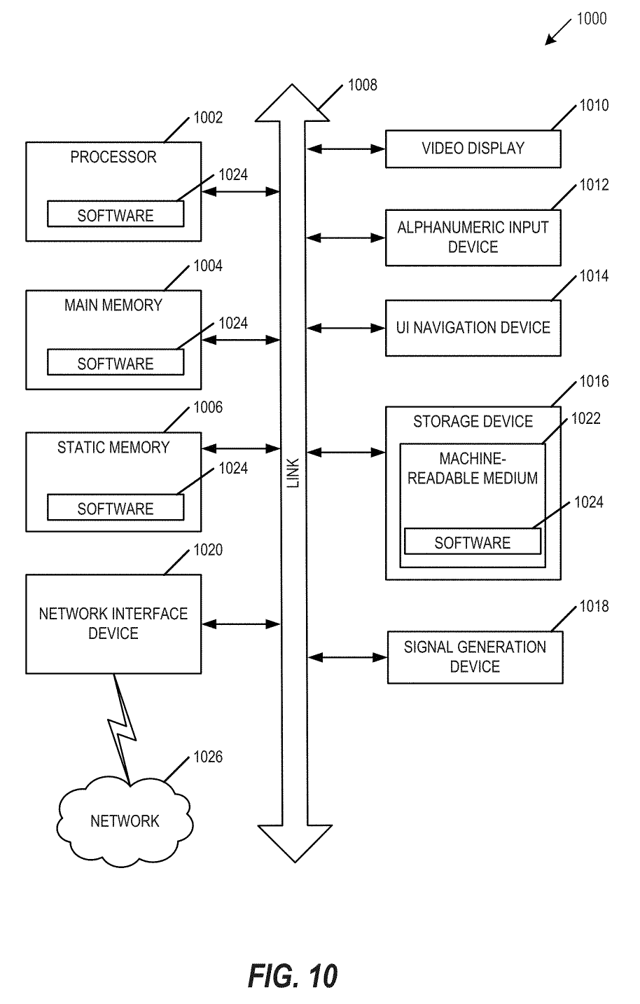

FIG. 10 is a block diagram illustrating an active stylus in the example form of a computer system 1000, within which a set or sequence of instructions may be executed to cause the machine to perform any one of the methodologies discussed herein, according to an example embodiment. Computer system 1000 may also represent the host shown in FIGS. 4-5, where the stylus and host are connected wirelessly or via a wired connection to exchange characterization or simulation data or processing. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a portable electronic device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 1000 includes at least one processor 1002 (e.g., a central processing unit (CPU), a graphics processing unit (GPU) or both, processor cores, compute nodes, etc.), a main memory 1004 and a static memory 1006, which communicate with each other via a link 1008 (e.g., bus). The computer system 1000 may further include a video display unit 1010, an alphanumeric input device 1012 (e.g., a keyboard), and a user interface (UI) navigation device 1014 (e.g., a mouse). In one embodiment, the video display unit 1010, input device 1012 and UI navigation device 1014 are incorporated into a touch screen display. The computer system 1000 may additionally include a storage device 1016 (e.g., a drive unit), a signal generation device 1018 (e.g., a speaker), a network interface device 1020, and one or more sensors (not shown), such as a global positioning system (GPS) sensor, compass, accelerometer, or other sensor.

The storage device 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004, static memory 1006, and/or within the processor 1002 during execution thereof by the computer system 1000, with the main memory 1004, static memory 1006, and the processor 1002 also constituting machine-readable media.

While the machine-readable medium 1022 is illustrated in an example embodiment to be a single medium, the term “machine-readable medium” may include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, Bluetooth, Bluetooth LE, 3G, 4G LTE/LTE-A, WiMAX networks, etc.). The term “transmission medium” shall be taken to include any intangible medium that is capable of storing, encoding, or carrying instructions for execution by the machine, and includes digital or analog communications signals or other intangible medium to facilitate communication of such software.

To better illustrate the method and apparatuses disclosed herein, a non-limiting list of embodiments is provided here:

Example 1 is a writing instrument characterization apparatus comprising: an audio input device to receive an audio input associated with a writing instrument while in use; a haptic input device to receive a haptic input associated with the writing instrument while in use; and a processor configured to generate an adaptive feedback model based on the audio input and haptic input.

In Example 2, the subject matter of Example 1 optionally includes wherein the adaptive feedback model includes an audio waveform associated with the writing instrument.

In Example 3, the subject matter of Example 2 optionally includes wherein the audio waveform is generated by applying an audio frequency analysis to the audio input to identify the audio waveform within a selected audio frequency range.

In Example 4, the subject matter of any one or more of Examples 1-3 optionally include wherein the adaptive feedback model includes a haptic waveform associated with the writing instrument.

In Example 5, the subject matter of Example 4 optionally includes wherein the haptic waveform is generated by applying a haptic frequency analysis to the haptic input to identify the haptic waveform within a selected haptic frequency range.

In Example 6, the subject matter of any one or more of Examples 1-5 optionally include a communication device to receive an adaptive feedback model update from a host, wherein the processor is further configured to update the adaptive feedback model based on the adaptive feedback model update.

In Example 7, the subject matter of Example 6 optionally includes wherein the communication device includes a network communication device to connect to the host and receive the adaptive feedback model update.

In Example 8, the subject matter of Example 7 optionally includes wherein: the adaptive feedback model includes a feedback software library; and receiving the adaptive feedback model update includes receiving a feedback software library update.

In Example 9, the subject matter of any one or more of Examples 1-8 optionally include wherein the audio input device includes a stylus microphone.

In Example 10, the subject matter of any one or more of Examples 1-9 optionally include wherein receiving the haptic input device includes a stylus haptic sensor.

In Example 11, the subject matter of Example 10 optionally includes wherein the stylus haptic sensor includes at least one of an accelerometer, a gyroscope, a pressure sensor, a variable reluctance sensor, and an inductive coil sensor.

In Example 12, the subject matter of any one or more of Examples 1-11 optionally include a simulation selection input device.

In Example 13, the subject matter of Example 12 optionally includes wherein the simulation selection input device receives a selection of a writing instrument to be simulated.

In Example 14, the subject matter of any one or more of Examples 12-13 optionally include wherein the simulation selection input device receives a selection of a writing surface to be simulated.

In Example 15, the subject matter of any one or more of Examples 1-14 optionally include a stylus motion input device to receive a stylus motion input.

In Example 16, the subject matter of Example 15 optionally includes wherein the processor is further configured to update the adaptive feedback model based on the stylus motion input.

In Example 17, the subject matter of any one or more of Examples 15-16 optionally include a stylus feedback device to provide a stylus feedback based on the adaptive feedback model and the stylus motion input.

In Example 18, the subject matter of Example 17 optionally includes wherein the stylus feedback device includes a stylus audio feedback device to provide an audio feedback.

In Example 19, the subject matter of any one or more of Examples 17-18 optionally include wherein the stylus feedback device includes a stylus haptic feedback device to provide a haptic feedback.

In Example 20, the subject matter of Example 19 optionally includes wherein the haptic feedback includes at least one of a tactile feedback and a kinesthetic feedback.

In Example 21, the subject matter of any one or more of Examples 19-20 optionally include wherein the haptic feedback device includes at least one of an actuator, an eccentric rotating mass, and an electromagnetic vibrator.

Example 22 is a writing instrument characterization method comprising: receiving an audio input associated with a writing instrument while in use; receiving a haptic input associated with the writing instrument while in use; and generating an adaptive feedback model based on the audio input and haptic input.

In Example 23, the subject matter of Example 22 optionally includes wherein the adaptive feedback model includes an audio waveform associated with the writing instrument.

In Example 24, the subject matter of Example 23 optionally includes wherein generating the adaptive feedback model includes applying an audio frequency analysis to the audio input to identify the audio waveform within a selected audio frequency range.

In Example 25, the subject matter of any one or more of Examples 22-24 optionally include wherein the adaptive feedback model includes a haptic waveform associated with the writing instrument.

In Example 26, the subject matter of Example 25 optionally includes wherein generating the adaptive feedback model includes applying a haptic frequency analysis to the haptic input to identify the haptic waveform within a selected haptic frequency range.

In Example 27, the subject matter of any one or more of Examples 22-26 optionally include receiving an adaptive feedback model update from a host; and updating the adaptive feedback model based on the adaptive feedback model update.

In Example 28, the subject matter of Example 27 optionally includes wherein: the host is remotely located; and the adaptive feedback model update is received from the host via a network connection.

In Example 29, the subject matter of Example 28 optionally includes wherein: the adaptive feedback model includes a feedback software library; and receiving the adaptive feedback model update includes receiving a feedback software library update.

In Example 30, the subject matter of any one or more of Examples 22-29 optionally include wherein receiving the audio input includes receiving the audio input from a stylus microphone.

In Example 31, the subject matter of any one or more of Examples 22-30 optionally include wherein receiving the haptic input includes receiving the haptic input from a stylus haptic sensor.

In Example 32, the subject matter of Example 31 optionally includes wherein the stylus haptic sensor includes at least one of an accelerometer, a gyroscope, a pressure sensor, a variable reluctance sensor, and an inductive coil sensor.

In Example 33, the subject matter of any one or more of Examples 22-32 optionally include receiving a selection of a writing instrument to be simulated.

In Example 34, the subject matter of Example 33 optionally includes receiving a selection of a writing surface to be simulated.

In Example 35, the subject matter of any one or more of Examples 22-34 optionally include receiving a stylus motion input.

In Example 36, the subject matter of Example 35 optionally includes updating the adaptive feedback model based on the stylus motion input.

In Example 37, the subject matter of any one or more of Examples 35-36 optionally include providing a stylus feedback based on the adaptive feedback model and the stylus motion input.

In Example 38, the subject matter of Example 37 optionally includes wherein providing the stylus feedback includes providing an audio feedback.

In Example 39, the subject matter of any one or more of Examples 37-38 optionally include wherein providing the stylus feedback includes providing a haptic feedback.

In Example 40, the subject matter of Example 39 optionally includes wherein providing the haptic feedback includes providing at least one of a tactile feedback and a kinesthetic feedback.

In Example 41, the subject matter of any one or more of Examples 39-40 optionally include wherein providing the haptic feedback includes providing the haptic feedback from a stylus haptic feedback mechanism.

In Example 42, the subject matter of Example 41 optionally includes wherein the haptic feedback mechanism includes at least one of an actuator, an eccentric rotating mass, and an electromagnetic vibrator.

Example 43 is at least one machine-readable medium including instructions, which when executed by a computing system, cause the computing system to perform any of the methods of Examples 22-42.

Example 44 is an apparatus comprising means for performing any of the methods of Examples 22-42.

Example 45 is a writing instrument characterization apparatus comprising: means for receiving an audio input associated with a writing instrument while in use; means for receiving a haptic input associated with the writing instrument while in use; and means for generating an adaptive feedback model based on the audio input and haptic input.

In Example 46, the subject matter of Example 45 optionally includes wherein the adaptive feedback model includes an audio waveform associated with the writing instrument.

In Example 47, the subject matter of Example 46 optionally includes wherein means for generating the adaptive feedback model includes means for applying an audio frequency analysis to the audio input to identify the audio waveform within a selected audio frequency range.

In Example 48, the subject matter of any one or more of Examples 45-47 optionally include wherein the adaptive feedback model includes a haptic waveform associated with the writing instrument.

In Example 49, the subject matter of Example 48 optionally includes wherein means for generating the adaptive feedback model includes means for applying a haptic frequency analysis to the haptic input to identify the haptic waveform within a selected haptic frequency range.

In Example 50, the subject matter of any one or more of Examples 45-49 optionally include means for receiving an adaptive feedback model update from a host; and means for updating the adaptive feedback model based on the adaptive feedback model update.

In Example 51, the subject matter of Example 50 optionally includes wherein: the host is remotely located; and means for receiving the adaptive feedback model update from the host via a network connection.

In Example 52, the subject matter of Example 51 optionally includes wherein: the adaptive feedback model includes a feedback software library; and means for receiving the adaptive feedback model update includes means for receiving a feedback software library update.

In Example 53, the subject matter of any one or more of Examples 45-52 optionally include wherein means for receiving the audio input includes means for receiving the audio input from a stylus microphone.

In Example 54, the subject matter of any one or more of Examples 45-53 optionally include wherein means for receiving the haptic input includes means for receiving the haptic input from a stylus haptic sensor.

In Example 55, the subject matter of Example 54 optionally includes wherein the stylus haptic sensor includes at least one of an accelerometer, a gyroscope, a pressure sensor, a variable reluctance sensor, and an inductive coil sensor.

In Example 56, the subject matter of any one or more of Examples 45-55 optionally include means for receiving a selection of a writing instrument to be simulated.

In Example 57, the subject matter of Example 56 optionally includes means for receiving a selection of a writing surface to be simulated.

In Example 58, the subject matter of any one or more of Examples 45-57 optionally include means for receiving a stylus motion input.

In Example 59, the subject matter of Example 58 optionally includes means for updating the adaptive feedback model based on the stylus motion input.

In Example 60, the subject matter of any one or more of Examples 58-59 optionally include means for providing a stylus feedback based on the adaptive feedback model and the stylus motion input.

In Example 61, the subject matter of Example 60 optionally includes wherein means for providing the stylus feedback includes means for providing an audio feedback.

In Example 62, the subject matter of any one or more of Examples 60-61 optionally include wherein means for providing the stylus feedback includes means for providing a haptic feedback.

In Example 63, the subject matter of Example 62 optionally includes wherein means for providing the haptic feedback includes means for providing at least one of a tactile feedback and a kinesthetic feedback.

In Example 64, the subject matter of any one or more of Examples 62-63 optionally include wherein means for providing the haptic feedback includes means for providing the haptic feedback from a stylus haptic feedback mechanism.

In Example 65, the subject matter of Example 64 optionally includes wherein the haptic feedback mechanism includes at least one of an actuator, an eccentric rotating mass, and an electromagnetic vibrator.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A writing instrument characterization apparatus comprising:
an audio input device to receive an audio input associated with a writing instrument while in use;
a haptic input device to receive a haptic input associated with the writing instrument while in use; and
a processor configured to generate an adaptive feedback model based on the audio input and haptic input.

2. The apparatus of claim 1, wherein the adaptive feedback model includes an audio waveform associated with the writing instrument.

3. The apparatus of claim 2, wherein the audio waveform is generated by applying an audio frequency analysis to the audio input to identify the audio waveform within a selected audio frequency range.

4. The apparatus of claim 1, wherein the adaptive feedback model includes a haptic waveform associated with the writing instrument.

5. The apparatus of claim 4, wherein the haptic waveform is generated by applying a haptic frequency analysis to the haptic input to identify the haptic waveform within a selected haptic frequency range.

6. The apparatus of claim 1, further including a communication device to receive an adaptive feedback model update from a host, wherein the processor is further configured to update the adaptive feedback model based on the adaptive feedback model update.

7. The apparatus of claim 6, wherein the communication device includes a network communication device to connect to the host and receive the adaptive feedback model update.

8. The apparatus of claim 1, wherein the audio input device includes a stylus microphone.

9. The apparatus of claim 1, wherein receiving the haptic input device includes a stylus haptic sensor.

10. The apparatus of claim 9, wherein the stylus haptic sensor includes at least one of an accelerometer, a gyroscope, a pressure sensor, a variable reluctance sensor, and an inductive coil sensor.

11. The apparatus of claim 1, further including a stylus motion input device to receive a stylus motion input.

12. The apparatus of claim 11, wherein the processor is further configured to update the adaptive feedback model based on the stylus motion input.

13. A writing instrument characterization method comprising:
receiving an audio input associated with a writing instrument while in use;
receiving a haptic input associated with the writing instrument while in use; and
generating an adaptive feedback model based on the audio input and haptic input.

14. The method of claim 13, wherein the adaptive feedback model includes an audio waveform associated with the writing instrument.

15. The method of claim 14, wherein generating the adaptive feedback model includes applying an audio frequency analysis to the audio input to identify the audio waveform within a selected audio frequency range.

16. The method of claim 13, wherein the adaptive feedback model includes a haptic waveform associated with the writing instrument.

17. The method of claim 16, wherein generating the adaptive feedback model includes applying a haptic frequency analysis to the haptic input to identify the haptic waveform within a selected haptic frequency range.

18. The method of claim 13, further including:
receiving an adaptive feedback model update from a host; and
updating the adaptive feedback model based on the adaptive feedback model update.

19. At least one machine-readable storage medium, comprising a plurality of instructions that, responsive to being executed with processor circuitry of a computer-controlled device, cause the computer-controlled device to:
receive an audio input associated with a writing instrument while in use;
receive a haptic input associated with the writing instrument while in use; and
generate an adaptive feedback model based on the audio input and haptic input.

20. The machine-readable storage medium of claim 19, wherein the adaptive feedback model includes an audio waveform associated with the writing instrument.

21. The machine-readable storage medium of claim 20, the instructions further causing the computer-controlled device to apply an audio frequency analysis to the audio input to identify the audio waveform within a selected audio frequency range.

22. The machine-readable storage medium of claim 19, wherein the adaptive feedback model includes a haptic waveform associated with the writing instrument.

23. The machine-readable storage medium of claim 22, the instructions further causing the computer-controlled device to apply a haptic frequency analysis to the haptic input to identify the haptic waveform within a selected haptic frequency range.
